(19) United States
(12) Patent Application Publication
(10) Pub. No.: US 2018/0250929 A1
(43) Pub. Date: Sep. 6, 2018

(54) CLEANING SYSTEM AND METHOD FOR DIGITAL OFFSET PRINTER

(71) Applicant: XEROX CORPORATION, Norwalk, CT (US)

(72) Inventors: Anthony S. CONDELLO, Webster, NY (US); Peter J. KNAUSDORF, Henrietta, NY (US); Jack T. LESTRANGE, Macedon, NY (US)

(21) Appl. No.: 15/448,365

(22) Filed: Mar. 2, 2017

(51) Int. Cl. B41F 35/00; B41F 7/24; B41F 7/02

(52) U.S. Cl. CPC B41F 35/002; B41F 7/02; B41F 7/24

(57) ABSTRACT

A viscosity control unit provides improved and efficient residual ink removal from an imaging member following the transfer of the majority of the ink from the imaging member to a substrate, and prior to the application of a subsequent ink application to the imaging member. The viscosity control unit hardens the residual ink on the imaging member to produce a hardened residual ink. By increasing the viscosity of the residual ink before it is removed by a cleaning station, the removal of the residual ink from the imaging member becomes easier and more efficient.

### FIELD OF DISCLOSURE

This invention relates generally to ink-based digital printing systems, and more particularly, to variable lithographic imaging member cleaning systems having a residual ink conditioning application prior to removing the residual ink from an imaging member.

### BACKGROUND

Conventional lithographic printing techniques cannot accommodate true high-speed variable data printing processes in which images to be printed change from impression to impression, for example, as enabled by digital printing systems. The lithography process is often relied upon, however, because it provides very high quality printing due to the quality and color gamut of the inks used. Lithographic inks are also less expensive than other inks, toners, and many other types of printing or marking materials.

Ink-based digital printing uses a variable data lithography printing system, or digital offset printing system, or a digital advanced lithography imaging system. A “variable data lithography system” is a system that is configured for lithographic printing using lithographic inks and based on digital image data, which may be variable from one image to the next. “Variable data lithography printing,” or “digital ink-based printing,” or “digital offset printing,” or digital advanced lithography imaging is lithographic printing of variable image data for producing images on a substrate that are changeable with each subsequent rendering of an image on the substrate in an image forming process.

For example, a digital offset printing process may include transferring radiation-curable ink onto a portion of an imaging member (e.g., fluorosilicone-containing imaging member, imaging blanket, printing plate) that has been selectively coated with a dampening fluid layer according to variable image data. According to a lithographic technique, referred to as variable data lithography, a non-patterned reimageable surface of the imaging member is initially uniformly coated with the dampening fluid layer. Regions of the dampening fluid are removed by exposure to a focused radiation source (e.g., a laser light source) to form pockets. A temporary pattern in the dampening fluid is thereby formed over the printing plate. Ink applied thereover is retained in the pockets formed by the removal of the dampening fluid. The inked surface is then brought into contact with a substrate at a transfer nip and the ink transfers from the pockets in the dampening fluid layer to the substrate. The dampening fluid may then be removed, a new uniform layer of dampening fluid applied to the printing plate, and the process repeated.

Digital printing is generally understood to refer to systems and methods of variable data lithography, in which images may be varied among consecutively printed images or pages. “Variable data lithography printing,” or “ink-based digital printing,” or “digital offset printing” are terms generally referring to printing of variable image data for producing images on a plurality of image receiving media substrates, the images being changeable with each subsequent rendering of an image on an image receiving media substrate in an image forming process. “Variable data lithographic printing” includes offset printing of ink images generally using specially-formulated lithographic inks, the images being based on digital image data that may vary from image to image, such as, for example, between cycles of an imaging member having a reimageable surface. Examples are disclosed in U.S. Patent Application Publication No. 2012/0103212 A1 (the '212 Publication) published May 3, 2012 based on U.S. patent application Ser. No. 13/095,714, and U.S. Patent Application Publication No. 2012/0103221 A1 (the '221 Publication) also published May 3, 2012 based on U.S. patent application Ser. No. 13/095,778. These applications are commonly assigned, and the disclosure of both are hereby incorporated by reference herein in their entirety.

Digital offset printing inks differ from conventional inks because they must meet demanding rheological requirements imposed by the variable data lithographic printing process while being compatible with system component materials and meeting the functional requirements of sub-system components, including wetting and transfer where the imaging member surface supports an image that is only printed once and is then refreshed. Each time the imaging member transfers its image to the print media or substrate, all history of that image remaining on the imaging member surface must be eliminated to avoid ghosting. Inevitably some film-splitting of the ink occurs at the transfer nip such that complete ink transfer to the print media cannot be guaranteed as residual ink may remain. This problem is a long felt need in the digital offset printing industry, with these systems requiring cleaning subsystems after the transfer nip to continuously remove post transfer residual ink from the reimageable surface of the imaging member prior to formation of the next print image. The inventors, aided by careful empirical testing and materials analysis, found and prescribe specific materials and system layout guidelines for more efficient and effective residual ink removal.

### SUMMARY

The following presents a simplified summary in order to provide a basic understanding of some aspects of one or more embodiments or examples of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later. Additional goals and advantages will become more evident in the description of the figures, the detailed description of the disclosure, and the claims.

The foregoing and/or other aspects and utilities embodied in the present disclosure may be achieved by providing an ink-based digital printing system useful for ink printing including an imaging member, an ink delivery unit, an ink image transfer station, a viscosity control unit and a cleaning station. The ink delivery unit deposits UV-curable ink over an imageable surface of the imaging member to form an ink image. The ink image transfer station transfers the ink image from the imageable surface to an image receiving media substrate, with the imageable surface having residual ink remaining on the surface after the transfer of the formed ink image. The viscosity control unit is configured to cure the residual ink on the imageable surface to produce a hardened residual ink. The cleaning station is configured to remove the hardened residual ink from the imageable surface, with the cleaning station physically contacting the hardened residual ink to remove the hardened residual ink from the imageable surface.

According to aspects described herein, a variable lithographic imaging member cleaning system may include a viscosity control unit and a cleaning station. The viscosity control unit may be positioned adjacent a variable lithographic imaging member silicone reimageable surface downstream of an ink transfer station in a printer process direction, with the ink image transfer station configured to transfer an ink image of patterned UV-curable ink from the reimageable surface to a media substrate with the reimageable surface having residual ink remaining on the reimageable surface after the transfer of the ink image. The viscosity control unit is configured to harden the residual ink on the reimageable surface to produce a hardened residual ink. The cleaning station may be positioned downstream the viscosity control unit in the printer process direction and before an ink delivery unit configured to deposit a next ink image of UV-curable ink onto the reimageable surface. The cleaning station is configured to remove the hardened residual ink from the reimageable surface prior to the deposit of the next ink image thereto.

According to aspects illustrated herein, ink-based digital printing method for ink printing includes depositing UV-curable ink over an imageable surface of an imaging member with an ink delivery unit to form an ink image, transferring the ink image from the imageable surface to an image receiving media substrate via an ink image transfer station positioned downstream of the ink delivery unit in a process direction, the imageable surface having residual ink remaining on the surface after the transfer of the formed ink image, curing the residual ink on the imageable surface with a viscosity control unit positioned downstream of the ink image transfer station in the process direction to produce a hardened residual ink, and removing the hardened residual ink from the imageable surface with cleaning station positioned downstream the viscosity control unit in the process direction.

Exemplary embodiments are described herein. It is envisioned, however, that any system that incorporates features of apparatus and systems described herein are encompassed by the scope and spirit of the exemplary embodiments.

### BRIEF DESCRIPTION OF THE DRAWINGS

Various exemplary embodiments of the disclosed apparatuses, mechanisms and methods will be described, in detail, with reference to the following drawings, in which like referenced numerals designate similar or identical elements, and:

FIG. 1 is a side view of a related art variable lithographic printing system;

FIG. 2 is a side view of a variable lithographic printing system with a roller based cleaning station usable with a viscosity control unit in accordance with an example of the embodiments; and

FIG. 3 is a flowchart depicting the operation of an exemplary variable lithographic printing system.

### DETAILED DESCRIPTION

Illustrative examples of the devices, systems, and methods disclosed herein are provided below. An embodiment of the devices, systems, and methods may include any one or more, and any combination of, the examples described below. This invention may, however, be embodied in many different forms and should not be construed as limited to the embodiments set forth below. Rather, these exemplary embodiments are provided so that this disclosure will be thorough and complete, and will fully convey the scope of the invention to those skilled in the art. Accordingly, the exemplary embodiments are intended to cover all alternatives, modifications, and equivalents as may be included within the spirit and scope of the apparatuses, mechanisms and methods as described herein.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value. For example, the term “about 2” also discloses the value “2” and the range “from about 2 to about 4” also discloses the range “from 2 to 4.”

The 212 Publication proposes systems and methods for providing variable data lithographic and offset lithographic printing or image receiving medium marking. The systems and methods disclosed in the 212 Publication are directed to improvements on various aspects of previously-attempted variable data digital imaging lithographic marking concepts based on variable patterning of dampening solutions (e.g., dampening fluids) to achieve effective truly variable digital data lithographic image forming.

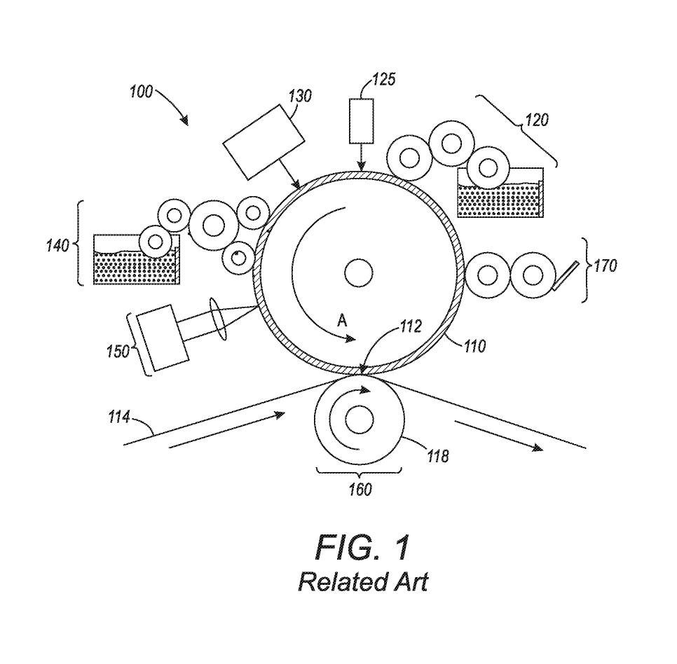

The 212 Publication describes, in requisite detail, an exemplary variable data lithography system 100 such as that shown, for example, in FIG. 1. A general description of the exemplary system 100 shown in FIG. 1 is provided here. Additional details regarding individual components and/or subsystems shown in the exemplary system 100 of FIG. 1 may be found in the 212 Publication.

As shown in FIG. 1, the exemplary system 100 may include an imaging member 110. The imaging member 110 in the embodiment shown in FIG. 1 is a drum, but this exemplary depiction should not be read in a manner that precludes the imaging member 110 being a plate or a belt, or of another known configuration. The imaging member 110 is used to apply an inked image to an image receiving media substrate 114 at a transfer nip 112. The transfer nip 112 is produced by an impression roller 118, as part of an image transfer mechanism 160, exerting pressure in the direction of the imaging member 110. Image receiving medium substrate 114 should not be considered to be limited to any particular composition such as, for example, paper, plastic, or composite sheet film. The exemplary system 100 may be used for producing images on a wide variety of image receiving media substrates. The 212 Publication also explains the wide latitude of marking (printing) materials that may be used, including marking materials with pigment densities greater than 10% by weight. As does the 212 Publication, this disclosure will use the term ink to refer to a broad range of printing or marking materials to include those which are commonly understood to be inks, pigments, and other materials which may be applied by the exemplary system 100 to produce an output image on the image receiving media substrate 114.

The 212 Publication depicts and describes details of the imaging member 110 including the imaging member 110 being comprised of a reimageable surface layer formed over a structural mounting layer that may be, for example, a cylindrical core, or one or more structural layers over a cylindrical core. The reimageable surface may be formed of a relatively thin layer over the mounting layer, a thickness of the relatively thin layer being selected to balance printing or marking performance, durability and manufacturability.

The exemplary system 100 includes a dampening fluid subsystem 120 generally comprising a series of rollers for uniformly wetting the reimageable surface of the imaging member 110 with a uniform layer of a dampening fluid, with a thickness of the layer being controlled. The dampening fluid may comprise water optionally with small amounts of isopropyl alcohol or ethanol added to reduce surface tension as well as to lower evaporation energy necessary to support subsequent laser patterning, as will be described in greater detail below. Experimental investigation has also shown low surface energy solvents such as volatile silicone oils can serve as dampening fluids, as well.

Once the dampening fluid is metered onto the reimageable surface of the imaging member 110, a thickness of the layer may be measured using a sensor 125 that may provide feedback to control the metering of the dampening fluid onto the reimageable surface by the dampening fluid subsystem 120.

Once a precise and uniform amount of dampening fluid is provided by the dampening fluid subsystem 120 on the reimageable surface, and optical patterning subsystem 130 may be used to selectively form a latent image in the uniform dampening fluid layer by image-wise patterning the dampening fluid layer using, for example, laser energy. The reimageable surface of the imaging member 110 should ideally absorb most of the laser energy emitted from the optical patterning subsystem 130 close to the surface to minimize energy wasted in heating the dampening fluid and to minimize lateral spreading of heat in order to maintain a high spatial resolution capability. Alternatively, an appropriate radiation sensitive component may be added to the dampening fluid to aid in the absorption of the incident radiant laser energy. While the optical patterning subsystem 130 is described above as being a laser emitter, it should be understood that a variety of different systems may be used to deliver the optical energy to pattern the dampening fluid.

The mechanics at work in the patterning process undertaken by the optical patterning subsystem 130 of the exemplary system 100 are described in detail with reference to FIG. 5 in the 212 Publication. Briefly, the application of optical patterning energy from the optical patterning subsystem 130 results in selective evaporation of portions of the layer of dampening fluid.

Following patterning of the dampening fluid layer by the optical patterning subsystem 130, the patterned layer over the reimageable surface is presented to an inker subsystem 140. The inker subsystem 140 is used to apply a uniform layer of ink over the layer of dampening fluid and the reimageable surface layer of the imaging member 110. The inker subsystem 140 may use an anilox roller to meter an offset lithographic ink onto one or more ink forming rollers that are in contact with the reimageable surface layer of the imaging member 110. The inker subsystem 140 may deposit the ink to the pockets representing the imaged portions of the reimageable surface, while ink deposited on the unformatted portions of the dampening fluid will not adhere based on a hydrophobic and/or oleophobic nature of those portions.

A cohesiveness and viscosity of the ink residing in the reimageable layer may be modified by a number of mechanisms. One such mechanism may involve the use of a rheology (complex viscoelastic modulus) control subsystem 150. The rheology control system 150 may form a partial crosslinking core of the ink on the reimageable surface to, for example, increase ink cohesive strength relative to the reimageable surface layer. Curing mechanisms may include optical or photo curing, heat curing, drying, or various forms of chemical curing. Cooling may be used to modify rheology as well via multiple physical cooling mechanisms, as well as via chemical cooling.

The ink is then transferred from the reimageable surface of the imaging member 110 to a substrate of image receiving medium 114 using a transfer subsystem 160. The transfer occurs as the substrate 114 is passed through a transfer nip 112 between the imaging member 110 and an impression roller 118 such that the ink within the voids of the reimageable surface of the imaging member 110 is brought into physical contact with the substrate 114. With the adhesion of the ink having been modified by the rheology control system 150, modified adhesion of the ink causes the ink to adhere to the substrate 114 and to separate from the reimageable surface of the imaging member 110. Careful control of the temperature and pressure conditions at the transfer nip 112 may allow transfer efficiencies to exceed 95%. While it is possible that some dampening fluid may also wet substrate 114, the volume of such a dampening fluid will be minimal, and will rapidly evaporate, or be absorbed by the substrate 114.

Following the transfer of the majority of the ink to the substrate 114 at the transfer nip 112, any residual ink and/or residual dampening fluid must be removed from the reimageable surface of the imaging member 110 to prepare the reimageable surface to repeat the digital image forming operation. This removal is most preferably undertaken without scraping or wearing the reimageable surface of the imaging member 110. An air knife or other like non-contact device may be employed to remove residual dampening fluid. It is anticipated, however, that some amount of ink residue may remain. Removal of such remaining ink residue may be accomplished through use of some form of cleaning subsystem 170. The 212 Publication describes details of such a cleaning subsystem 170 including at least a first cleaning member such as a sticky or tacky member in physical contact with the reimageable surface of the imaging member 110, the sticky or tacky member removing residual ink and remaining small amounts of surfactant compounds from the dampening fluid of the reimageable surface of the imaging member 110. The sticky or tacky member may then be brought into contact with a smooth roller to which residual ink may be transferred from the sticky or tacky member, the ink being subsequently stripped from the smooth roller by, for example, a doctor blade or other like device and collected as waste.

The 212 Publication details other mechanisms by which cleaning of the reimageable surface of the imaging member 110 may be facilitated. Regardless of the cleaning mechanism, however, cleaning of the residual ink and dampening fluid from the reimageable surface of the imaging member 110 is essential to preventing ghosting in subsequent image forming operations as the images change. Once cleaned, the reimageable surface of the imaging member 110 is again presented to the dampening fluid subsystem 120 by which a fresh layer of dampening fluid is supplied to the reimageable surface of the imaging member 110, and the process is repeated.

The disclosed embodiments are examples intended to cover systems and methods for improved and efficient residual ink removal from an imaging member following the transfer of the majority of the ink from the imaging member to a substrate, and prior to the application of a fresh layer of dampening fluid to the reimageable surface of the imaging member. The examples include a pre-cleaning device for inks (e.g., ultra-violet (UV) curable inks) in an ink-based digital printing system (e.g., a variable data digital lithographic printer). When squeezed between two rollers at a transfer nip, UV ink tends to film-split. That is, UV ink cohesively fails, resulting in a separation of the ink between two mating surfaces. The disclosed examples expose the post-transfer imaged section of the imaging member to a given amount of UV radiation (# of photons) in order to polymerize the residual ink to a state that promotes more thorough single pass cleaning. UV ink hardens when exposed to UV radiation. By increasing the viscosity of the residual ink before it is removed by a cleaning station, the removal of the residual ink from the imaging member becomes easier and more efficient. It should be noted that the examples are not limited to UV ink exposed to UV radiation post-transfer and pre-cleaning, as other inks are considered within the scope of the invention where the cohesive bond of the residual ink is increased, for example, by increasing its viscosity pre-cleaning. The inventors found that increasing the cohesive bond of the residual ink pre-cleaning from the imaging member improves the affective cleaning of the imaging member surface. The ink once hardened will no longer split, and may be removed completely by a cleaning system or mechanism. In addition, the scope is not limited to any cleaning mechanism, with exemplary cleaning mechanisms including a roller, brush, web, tacky roller, buffing wheel, etc. It is also understood that the level of curing/thickening/hardening needed may depend on the type of cleaning mechanism selected.

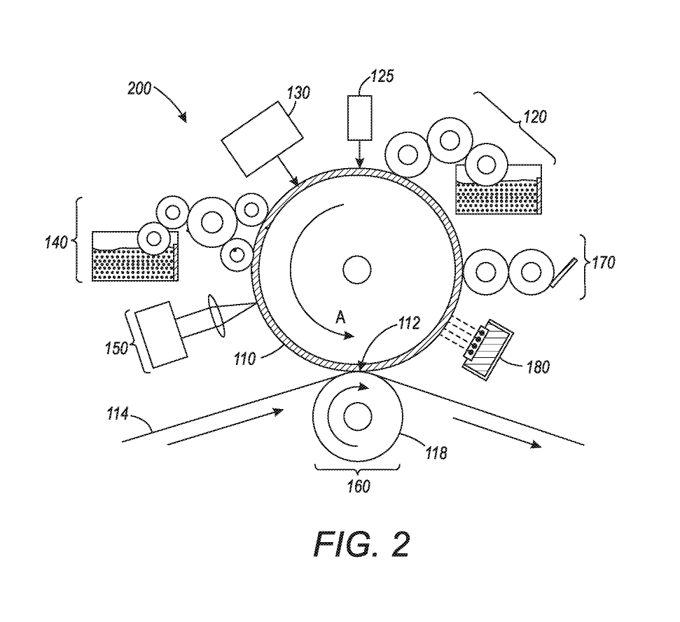

FIG. 2 illustrates a schematic representation of a first exemplary embodiment of an ink-based digital printing system, including a variable data digital lithographic image forming device 200 according to this disclosure. As shown in FIG. 2, the variable data digital lithographic image forming device may be adapted to pattern a control/release agent (e.g., silicone oil) layer on a reimageable surface of an imaging member 110 (e.g., pattern transfer drum, imaging blanket). The reimageable conformable surface may include a conformable surface layer of a fluoroelastomer formed over a structural mounting layer that may be, for example, a cylindrical core, or one or more structural layers over a cylindrical core. Note that certain of the components associated with the variable data lithography system shown in FIG. 1 may be omitted in FIG. 2 for clarity.

The exemplary system 200 includes the dampening fluid subsystem 120 dampening fluid subsystem configured to deposit a layer of dampening fluid onto the surface of the imaging member 110. While not being limited to particular configuration, the exemplary dampening fluid subsystem may include a series of rollers or sprays for uniformly wetting the reimageable surface of the imaging member 110 with a uniform layer of a dampening fluid, with a thickness of the layer being controlled. As noted above, the dampening fluid may comprise water optionally with small amounts of isopropyl alcohol or ethanol added to reduce surface tension as well as to lower evaporation energy necessary to support subsequent laser patterning, as will be described in greater detail below. Low surface energy solvents such as volatile silicone oils can also serve as dampening fluids. A thickness of the dampening fluid layer may be measured using a sensor 125 that may provide feedback to control the metering of the dampening fluid onto the reimageable surface by the dampening fluid subsystem 120.

The optical patterning subsystem 130 is located downstream the dampening fluid subsystem 120 in the processing direction to selectively pattern a latent image in the layer of dampening fluid by image-wise patterning the dampening fluid layer using, for example, laser energy. While the optical patterning subsystem 130 is described above as being a laser emitter, it should be understood that a variety of different systems may be used to deliver the optical energy to pattern the dampening fluid.

Following patterning of the dampening fluid layer by the optical patterning subsystem 130, the patterned layer over the reimageable surface is presented to an inker subsystem 140. The inker subsystem 140 is positioned downstream the optical patterning subsystem to apply a uniform layer of ink over the layer of dampening fluid and the reimageable surface layer of the imaging member 110. While not being limited to a particular configuration, the inker subsystem may use an anilox roller to meter an offset lithographic ink onto one or more ink forming rollers that are in contact with the reimageable surface layer of the imaging member 110. The inker subsystem 140 may deposit the ink to the pockets representing the imaged portions of the reimageable surface, while ink deposited on the unformatted portions of the dampening fluid will not adhere based on a hydrophobic and/or oleophobic nature of those portions.

Although the ink is discussed herein as a UV-curable ink, the disclosed embodiments are not intended to be limited to such a construct. The ink may be a UV-curable ink or another ink that hardens when exposed to UV radiation. The ink may be another ink having a cohesive bond that increases, for example, by increasing its viscosity. For example, the ink may be a solvent ink or aqueous ink that hardens when exposed to a thermal cooler. As another example, a heater may be used to at least partially dry the ink, which may be preferred for increasing the cohesive bond of aqueous ink.

Downstream the ink delivery unit in the process direction resides an ink image transfer station that transfers the ink image from the imaging member surface to a substrate of image receiving medium 114. The transfer occurs as the substrate 114 is passed through a transfer nip 112 between the imaging member 110 and an impression roller 118 such that the ink within the voids of the reimageable surface of the imaging member 110 is brought into physical contact with the substrate 114.

As discussed above, despite previous best efforts, including the rheological conditioning system 150 that may increase the ink's viscosity of the ink image before transfer of the ink image to the image receiving media substrate, not all of the ink may transfer to the substrate at the transfer nip 112. Thus, the re-imageable surface of the imaging member will have residual ink remaining thereon after the transfer of the formed ink image. To maximize residual ink removal by the cleaning station 170, a viscosity control unit 180 positioned downstream of the ink image transfer station in the process direction increases the residual ink cohesive strength on the imaging member surface to produce a hardened residual ink. The viscosity control unit may be a rheological conditioning system placed between the transfer nip 112 and the cleaning station 170 as a pre-cleaning device that forms a partial crosslinking core of the ink on the reimageable surface to, for example, increase ink cohesive strength relative to the reimageable surface layer. In particular, the viscosity control unit conditions the residual ink prior to removing the residual ink from the imaging member, for example by curing the residual ink, to increase the residual ink cohesive strength relative to the reimageable surface layer. Those skilled in the art would recognize that viscosity control units within the scope of invention may include radiation curing, optical or photo curing, heat curing, drying, or various forms of chemical curing. Cooling may be used by a viscosity control unit to modify rheology as well, for example, via physical and/or chemical cooling mechanisms.

The viscosity control unit 180 shown in FIG. 2 is a UV exposure station with a UV curing lamp (e.g., standard laser, UV laser, high powered UV LED light source) that exposes the residual ink on the imaging member surface to an amount of UV light (e.g., # of photons radiation) to polymerize the residual ink to a state that promotes more thorough single pass cleaning. In other words, the viscosity control unit actively hardens the residual ink contamination remaining on the imaging member reimageable surface to make the contamination brittle and easier to remove. The hardened residual ink will no longer split, meaning that it will either stay on the imaging member surface or be removed completely.

The level of UV light dosage sufficient to harden the residual ink may depend on several factors, such as the ink formulation (e.g., UV photo initiator type, concentration), UV lamp spectrum, printer processing speed and amount of residual ink on the imaging member 110 surface. While not being limited to a particular range, for an exemplary UV curing lamp (e.g., about 395 nm LED), the inventors through extensive experimentation found that a range of UV light photons from about 30 mJ/cm² to 600 mJ/cm² may sufficiently increase the viscosity of the residual ink on the imaging member surface for subsequent removal.

A cleaning station 170 positioned downstream the viscosity control unit in the process direction removes the hardened residual ink from the reimageable surface prior to a delivery or deposit of a next ink image thereto by the inker subsystem 140. The cleaning subsystem 170 includes at least a first cleaning member such as a sticky or tacky member in physical contact with the reimageable surface of the imaging member 110, the sticky or tacky member removing the hardened residual ink and remaining small amounts of surfactant compounds from the dampening fluid of the reimageable surface of the imaging member 110. The sticky or tacky member may then be brought into contact with a smooth roller to which residual ink may be transferred from the sticky or tacky member, the ink being subsequently stripped from the smooth roller by, for example, a doctor blade or other like device and collected as waste.

It is understood that the cleaning station 170 is one of numerous types of cleaning stations and that other cleaning stations designed to remove residual ink from a reimageable surface of a digital printing system imaging member are considered within the scope of the embodiments. For example, the cleaning station could include at least one roller, brush, web, tacky roller, buffing wheel, etc., as well understood by a skilled artisan. It is also understood that the level of curing or hardening may predictably depend on the type of cleaning station selected.

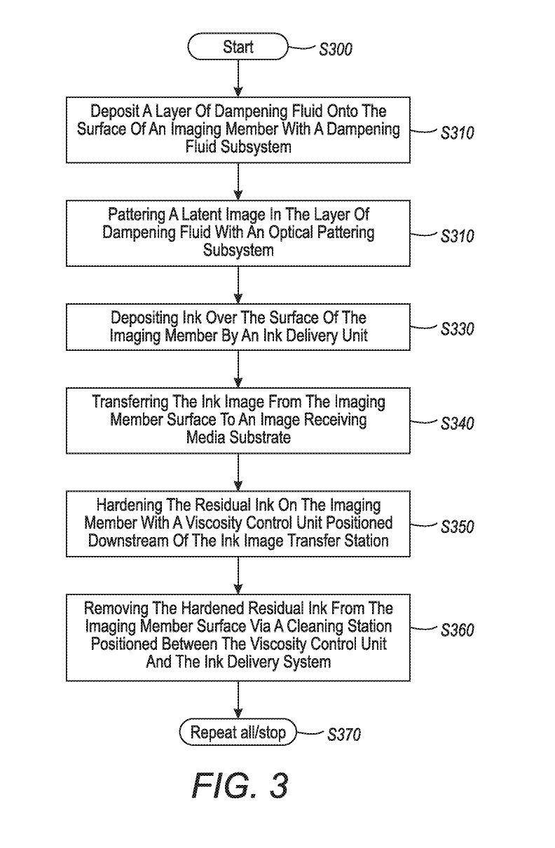

The disclosed embodiments may include an exemplary ink-based digital printing method implementing a variable data deposition and image forming process with a residual ink conditioning and cleaning device/technique. FIG. 3 illustrates a flowchart of such an exemplary method. As shown in FIG. 3, operation of the method commences at Step S300 and proceeds to Step S310.

In Step S310, a layer of dampening fluid may be deposit onto the surface of an imaging member with a dampening fluid subsystem. The surface of the imaging member may be a reimageable conformable surface layer including a fluoroelastomer. Operation of the method proceeds to Step S320, where a latent image may be selectively patterned in the layer of dampening fluid with an optical patterning subsystem located downstream the dampening fluid subsystem in the processing direction. Operation of the method proceeds to Step S330.

In Step S330, a UV-curable ink may be deposited over a reimageable surface of the imaging member by an ink delivery unit located downstream the optical patterning subsystem to form an ink image. Operation of the method proceeds to Step S340, where the ink image may be transferred from the imaging member surface to an image receiving media substrate via an ink image transfer station positioned downstream of the ink delivery unit in the process direction, this operation may leave residual ink on the imaging member surface after the transfer of the formed ink image. Operation of the method proceeds to Step S350.

In Step S350, the residual ink on the imaging member surface may be cured or rendered brittle with a viscosity control unit positioned downstream of the ink image transfer station in the process direction to produce a hardened residual ink. Curing the residual ink may include increasing the residual ink cohesive strength relative to the surface layer of the imaging member. Operation the method proceeds to Step S360.

In Step S360, the hardened residual ink may be removed from the imaging member surface via a cleaning station positioned between the viscosity control unit and the ink delivery unit in the process direction. Of course the cleaning station may be located before the dampening fluid subsystem and the optical patterning subsystem. Removing the hardened residual ink from the imaging member surface may include physically scrubbing the hardened residual ink from the surface with the cleaning station in contact with the hardened residual ink. Operation the method may cease at Step S370, or may repeat back to Step S310, where a new layer of dampening fluid may be deposited onto the surface of an imaging member.

The above-described exemplary systems and methods may reference certain conventional image forming device components to provide a brief, background description of image forming approaches that may be adapted to carry into effect the variable data digital control/release agent layer deposition processes in support of the disclosed schemes. No particular limitation to a specific configuration of the variable data digital lithography portions or modules of a residual ink conditioning system is to be construed based on the description of the exemplary elements depicted and described above.

Those skilled in the art will appreciate that other embodiments of the disclosed subject matter may be practiced with many types of image forming elements common to lithographic image forming systems in many different configurations. It should be understood that these are non-limiting examples of the variations that may be undertaken according to the disclosed schemes. In other words, no particular limiting configuration is to be implied from the above description and the accompanying drawings.

The exemplary depicted sequence of executable method steps represents one example of a corresponding sequence of acts for implementing the functions described in the steps. The exemplary depicted steps may be executed in any reasonable order to carry into effect the objectives of the disclosed embodiments. No particular order to the disclosed steps of the method is necessarily implied by the depiction in FIG. 3, and the accompanying description, except where any particular method step is reasonably considered to be a necessary precondition to execution of any other method step. For example, the residual ink conditioning step S350 occurs after the image transfer step S340 and before the residual ink is removed from the imaging member surface at step S360. Individual method steps may be carried out in sequence or in parallel in simultaneous or near simultaneous timing. Additionally, not all of the depicted and described method steps need to be included in any particular scheme according to disclosure.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art.

What is claimed is:

1. An ink-based digital printing system, comprising:
an imaging member having an imageable surface;
an ink delivery unit that deposits ink over the imageable surface to form an ink image,
an ink image transfer station positioned downstream of the ink delivery unit in a process direction that transfers the ink image from the imageable surface to an image receiving media substrate, the imageable surface having residual ink remaining on the surface after the transfer of the formed ink image;
a viscosity control unit positioned downstream of the ink image transfer station in the process direction and configured to change the viscosity of the residual ink on the imageable surface to produce a hardened residual ink; and
a cleaning station positioned downstream the viscosity control unit in the process direction, the cleaning station configured to remove the hardened residual ink from the imageable surface, the cleaning station physically contacts the hardened residual ink to remove the hardened residual ink from the imageable surface.

2. The ink-based digital printing system of claim 1, further comprising a dampening fluid subsystem positioned upstream the ink delivery unit in the processing direction, the dampening fluid subsystem configured to deposit a layer of dampening fluid onto the imageable surface of the imaging member.

3. The ink-based digital printing system of claim 2, further comprising an optical patterning subsystem between the dampening fluid subsystem and the ink delivery unit in the processing direction, the optical patterning subsystem configured to selectively pattern a latent image in the layer of dampening fluid, the ink delivery unit configured to deposit the ink on the latent image to form the ink image.

4. The ink-based digital printing system of claim 1, wherein the imageable surface of the imaging member is a reimageable conformable surface layer.

5. The ink-based digital printing system of claim 1, wherein the ink is a UV-curable ink, and the viscosity control unit is configured to cure the residual ink on the imageable surface to produce the hardened residual ink.

6. The ink-based digital printing system of claim 1, the viscosity control unit configured to increase residual ink cohesive strength relative to the imageable surface layer.

7. The ink-based digital printing system of claim 1, wherein the cleaning station physically contacts the hardened residual ink to remove the hardened residual ink from the imageable surface.

8. The ink-based digital printing system of claim 1, further comprising a rheological conditioning system configured to increase a viscosity of the ink image before transfer of the ink image to the image receiving media substrate.

9. An ink-based digital printing method, comprising:
depositing ink over an imageable surface of an imaging member with an ink delivery unit to form an ink image,
transferring the ink image from the imageable surface to an image receiving media substrate via an ink image transfer station positioned downstream of the ink delivery unit in a process direction, the imageable surface having residual ink remaining on the surface after the transfer of the formed ink image;
changing the viscosity of the residual ink on the imageable surface with a viscosity control unit positioned downstream of the ink image transfer station in the process direction to produce a hardened residual ink; and
removing the hardened residual ink from the imageable surface with cleaning station positioned downstream the viscosity control unit in the process direction.

10. The method of claim 9, further comprising depositing a layer of dampening fluid onto the imageable surface of the imaging member with a dampening fluid subsystem positioned upstream the ink delivery unit in the processing direction.

11. The method of claim 10, further comprising selectively patterning a latent image in the layer of dampening fluid with an optical patterning subsystem between the dampening fluid subsystem and the ink delivery unit in the processing direction, the ink delivery unit configured to deposit the ink on the latent image to form the ink image.

12. The method of claim 9, wherein the imageable surface of the imaging member is a reimageable conformable surface layer.

13. The method of claim 9, wherein the ink is a UV-curable ink, and the viscosity control unit cures the residual ink on the imageable surface to produce the hardened residual ink.

14. The method of claim 9, the step of curing the residual ink including increasing the residual ink cohesive strength relative to the imageable surface layer with the viscosity control unit.

15. The method of claim 9, the step of removing the hardened residual ink from the imageable surface including physically scrubbing the hardened residual ink from the imageable surface with the cleaning station in contact with the hardened residual ink.

16. The method of claim 9, further comprising increasing a viscosity of the ink image with a rheological conditioning system before transferring the ink image from the imageable surface to the image receiving media substrate.

17. A variable lithographic imaging member cleaning system, comprising:
a viscosity control unit positioned adjacent a variable lithographic imaging member silicone reimageable surface downstream of an ink transfer station in a printer process direction, the ink image transfer station configured to transfer an ink image of patterned UV-curable ink from the reimageable surface to a media substrate with the reimageable surface having residual ink remaining on the reimageable surface after the transfer of the ink image, the viscosity control unit configured to cure the residual ink on the reimageable surface to produce a hardened residual ink; and
a cleaning station positioned downstream the viscosity control unit in the printer process direction and before an ink delivery unit configured to deposit a next ink image of UV-curable ink onto the reimageable surface, the cleaning station configured to remove the hardened residual ink from the reimageable surface prior to the deposit of the next ink image thereto.

18. The system of claim 17, the viscosity control unit configured to increase residual ink cohesive strength relative to the reimageable surface layer.

19. The system of claim 17, wherein the cleaning station physically contacts the hardened residual ink to remove the hardened residual ink from the reimageable surface.

20. The system of claim 17, further comprising a rheological conditioning system configured to increase a viscosity of the ink image before transfer of the ink image to the image receiving media substrate.
